(19) United States
(12) Patent Application Publication
(10) Pub. No.: US 2010/0127598 A1
(43) Pub. Date: May 27, 2010

(54) MINIATURE PIEZOELECTRIC MOTORS FOR ULTRA HIGH-PRECISION STEPPING

(75) Inventors: Bruce C. Sun, Fremont, CA (US); Tzong-Shii Pan, San Jose, CA (US)

Correspondence Address: PILLSBURY WINTHROP SHAW PITTMAN LLP, P.O. BOX 10500, MCLEAN, VA, 22102, US

(73) Assignee: Ceradigm, Corp., Fremont, CA (US)

(21) Appl. No.: 12/623,258

(22) Filed: Nov. 20, 2009

Related U.S. Application Data
(60) Provisional application No. 61/199,945, filed on Nov. 21, 2008.
(60) Provisional application No. 61/214,945, filed on Apr. 29, 2009.

(51) Int. Cl. H02N 2/12

(52) U.S. Cl. 310/323.02

(57) ABSTRACT

A miniature piezoelectric motor is described whereby in one embodiment teethed protrusions emanating inward from an annular-shaped stator engage with a rotor as the stator deforms in response to stresses applied to the stator by PZT pads attached thereto. The PZT pads are driven by voltage waveforms according to either a standing or traveling wave method and each deformation of the stator applies a tangential force to the rotor via a plurality of teethed protrusions, thereby moving the rotor a small amount. Flat PZT pads attached to flat facets on conductive surfaces of the stator are utilized in order to increase manufacturability and reduce cost. Configuration of the facets tunes the resonant frequency of the stator ensuring that the motor operates in the ultrasonic range, and also tunes the voltage level of drive signal required. Placement of PZT elements on the inner circumferential surface further optimizes overall motor size.

### CLAIM OF PRIORITY

This application claims the benefit and priority of U.S. Provisional Application Ser. No. 61/199,945, filed on Nov. 21, 2008, and entitled “Miniature Piezoelectric Motors for Ultra High-Precision Stepping,” and U.S. Provisional Application Ser. No. 61/214,945, filed on Apr. 29, 2009, and entitled “Ultra High-Precision Linear Driving Mechanism Using Miniature Piezoelectric Motors,” both of said Provisional Applications commonly assigned with the present application and incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates to the field of electrical motors and motor technology as well as camera lenses and actuation mechanisms that move and/or rotate camera lenses.

### BACKGROUND OF THE INVENTION

As miniaturization continues its evolutionary path in many fields of endeavor, the need for smaller and smaller precision motors is ever present. Such motors are useful in many fields of endeavor, including medical, military, and consumer electronics applications. With the advent of notebook computers and especially handheld computing devices such as PDAs and smart phones as well as digital cameras, growing markets exist for miniature motors that are both low power and high precision. A very suitable mechanism for driving such motors is based on utilizing piezoelectric elements. New technologies using piezoelectric [PZT or Pb(Ti, Zr)O₃] driven mechanisms are known and have the advantage of extremely small size and low-power consumption. Prior art examples of a PZT driven motor are known where a stator surrounds a rotor and through deformation of the stator, it engages with the rotor in order to drive it. Both rotational and linear versions of such motors are known, however the rotational version is especially useful for positioning the lens in a miniature camera (for autofocus, zoom, or both), since the rotor can have a hollow center in which a lens can be carried, a light path being established axially through the lens and motor assembly.

A miniature lens and motor assembly may find application in a number of consumer electronic devices, including smart phones, PDAs, and notebook computers in addition to the obvious application of digital cameras. Since these are all devices that are used in close contact with people, it is important that the motor not make annoying noises as it operates.

It is also important that a miniature motor utilize as little space as possible. The circuitry that drives the motor should be compact and efficient, requiring as little input power as possible over that which is required to actually drive the motor. In this regard, it is useful if the voltage level required to properly drive the PZT elements on the motor is as low as possible.

Additionally, a miniature motor should have a low manufacturing cost and be easy to assemble—especially in very high volume applications. Prior art rotary piezoelectric motors utilize curved PZT elements which are difficult to construct, difficult to attach, and have a reputation for less than desired reliability due to the fragile nature of the curved PZT.

### SUMMARY OF THE INVENTION

According to the present invention, a miniature electric motor is described that uses the stresses induced in an annular shaped teethed structure by the flat PZT pads attached thereto in order to deform the teethed structure which is comprised of a resilient material. As the teethed structure deforms, teeth protruding inward from the teethed structure intermittently contact a cylindrical center piece and move the cylindrical center piece or the teethed structure by very small increments, enabling positioning the rotated structure with a fine degree of accuracy. A motor per the present invention will normally be driven at its resonant frequency where a maximum amount of deformity can be achieved with a minimum amount of voltage/energy applied to the PZT pads. The resonant frequency for an annular teethed structure depends on a number of variables including the material it comprises, the cross-sectional thickness of the teethed structure, and the shape of the teethed structure. Per this invention, the shape of the teethed structure has been modified by introducing a plurality of flat facets that serve two purposes. First, they provide locations to apply flat PZT pads—a solution that is far more cost effective and reliable than attempting to apply curved PZT elements to a teethed structure. Second, the number and shape of the facets can be altered along with the thickness of the teethed structure in order to vary the resonant frequency of the teethed structure.

Some of the applications for such a miniature motor include handheld devices such as cell phones and digital cameras where the motor positions a lens for the purpose of auto focus, zoom, or both. Since these devices are used by people, it is important that the operation of the motor is silent with an operational sonic frequency that is always greater than 20 KHz—the generally agreed upon limit of human hearing. A motor whose resonant frequency is in the audible range of human hearing would be quite annoying and in the end, would not be a commercial success.

One aspect of the present invention is to provide a miniature piezoelectric motor that has facets on the outer surface of the teethed structure with flat PZT pads attached to each facet. The inner surface of the teethed structure may be either curved or faceted, except where a plurality of protrusions emanate inward for the teethed structure toward its center. An alternate embodiment provides for a smaller number of flat facets where attached to each facet is a PZT pad comprising dual electrode co-planer segments that are polarized similarly.

Another aspect of the present invention is to provide a miniature piezoelectric motor that has facets on the inner surface of the teethed structure with flat PZT pads attached to each facet. On the inner surface of the teethed structure, there are also a plurality of protrusions that emanate inward from the teethed structure toward the center of the teethed structure, with the PZT pads attached between protrusions. Placing the PZT pads on the inner surface has the added advantage of making the overall dimensions of the motor smaller since the PZT pads reside in the spaces between protrusions that would otherwise have been wasted space. The outer surface of the teethed structure for this embodiment may be either curved or faceted. An alternate embodiment provides for a smaller number of flat facets where attached to each facet is a PZT pad comprising dual-electrode co-planer segments that are polarized similarly.

Another aspect of the present invention is to provide a miniature piezoelectric motor that has facets on both the inner and outer circumferential surfaces of the teethed structure with flat PZT pads attached to each facet.

Another aspect of the present invention is to provide a miniature piezoelectric motor that may be driven by either standing or traveling wave methodologies.

Another aspect of the present invention is to provide high precision stepping whereby the rotated structure is positioned in very small dimensional increments.

Another aspect of the present invention is that the rotated structure is inherently held in position when voltages are not applied to the PZT elements.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 shows a prior art PZT motor with curved PZT elements.

FIG. 2 shows the PK1 embodiment of the present invention describing an annular or cylindrical Teethed Structure (TS) to which plurality of PZT elements of proper polarities may be later attached.

FIG. 3 shows the PK1 embodiment including an annular teethed structure with eight single-electrode PZT flat elements or pads attached to facets.

FIG. 4 shows the a cylindrical threaded center piece (TCP) structure that fits inside a teethed structure such as in the PK1 embodiment shown in FIG. 3.

FIG. 5 shows the components of a miniature piezoelectric motor embodiment, PK1, based on the teethed structure shown in FIG. 3.

FIG. 6 shows the deformation of a teethed structure with PZT pads attached, and how it is electrically driven with a standing wave methodology in order to cause rotation in a first direction.

FIG. 7 shows the deformation of a teethed structure with PZT pads attached, and how it is electrically driven with a standing wave methodology in order to cause rotation in a second direction.

FIG. 8 shows the deformation of a teethed structure with PZT pads attached, and how it is electrically driven with a traveling wave methodology.

FIG. 9 shows the PK1_f embodiment of an annular teethed structure with both its outer circumferential surface and inner circumferential surface cut in flat facets.

FIG. 10 shows the PK1_f teethed structure where eight single-electrode PZT elements/pads have been attached to facets on the exterior circumferential surface.

FIG. 11 shows the PK1_f embodiment of a miniature piezoelectric motor.

FIG. 12 shows the PK2 embodiment of a teethed structure having 4 facets on the external circumferential surface and four co-planar dual-electrode PZT elements forming an 8-pole deformation structure.

FIG. 13 shows a miniature piezoelectric motor embodiment, PK2, based on the TS/PZT embodiment shown in FIG. 12.

FIG. 14 shows an embodiment of the PK2_f-teethed structure having four facets and four dual-electrode PZT elements forming an 8-pole deformation structure.

FIG. 15 shows a miniature piezoelectric motor embodiment, PK2_f, based on the TS/PZT embodiment shown in FIG. 14.

FIG. 16 shows the CK1 embodiment of an annular teethed structure with its outer circumferential surface in circular finish and inner circumferential surface cut in flat facets to which a plurality of PZT elements or pads of proper polarities may be attached to form a structure for deformation when driven by the proper control signal of certain amplitude and frequency.

FIG. 17 shows the teethed structure of the CK1 embodiment as in FIG. 16 with eight single-electrode PZT elements attached to the facets on the inner circumferential surface of the teethed structure forming an 8-pole deformation structure.

FIG. 18 shows a miniature piezoelectric motor embodiment, CK1, based on the TS/PZT embodiment shown in FIG. 17.

FIG. 19 shows the CK1_f embodiment of a teethed structure and eight single-electrode PZT elements 1902 forming an 8-pole deformation structure. Here, both the outer circumferential surface and inner circumferential surface of the teethed structure are faceted.

FIG. 20 shows a miniature piezoelectric motor embodiment, CK1_f, based on the TS/PZT embodiment shown in FIG. 19.

FIG. 21 shows the CK2 embodiment of a teethed structure where four dual-electrode PZT co-planar elements are attached on the inner circumferential surface of the annular teethed structure thereby forming an 8-pole deformation structure.

FIG. 22 shows a miniature piezoelectric motor embodiment, CK2, based on the TS/PZT embodiment shown in FIG. 21.

FIG. 23 shows the CK2_f embodiment of a teethed structure where four dual-electrode coplanar PZT elements are attached on the inner circumferential surface of the annular teethed structure thereby forming an 8-pole deformation structure. In this embodiment, both the inner circumferential surface and outer circumferential surface of the annular teethed structure are faceted.

FIG. 24 shows a miniature piezoelectric motor embodiment, CK2_f, based on the TS/PZT embodiment shown in FIG. 23.

FIG. 25 shows eight embodiments of an annular teethed structure and attached PZT elements as previously described in FIGS. 3, 10, 12, 14, 17, 19, 21, and 23. Under the image for each embodiment is shown the resonant frequency for that embodiment as determined by finite element analysis and simulation.

FIG. 26 shows the PCK1 embodiment of an annular teethed structure 2601 where both the inner and outer circumferential surfaces of the annular teethed structure are faceted.

FIG. 27 shows a miniature piezoelectric motor embodiment, PCK1, based on the TS/PZT embodiment shown in FIG. 26.

FIG. 28 shows the mounting of a PK1 Type 1 miniature piezoelectric motor using a mounting bracket.

FIG. 29 shows a PK1 Type 1 miniature piezoelectric motor with hard stop tabs on the Stator that determine the limit of travel for the rotor.

FIG. 30 shows the mounting of a PK1 Type 2 miniature piezoelectric motor using a mounting disk which also acts as the hard stop for the rotor.

### DETAILED DESCRIPTION OF THE INVENTION

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Moreover, while the motor mechanisms shown in this specification are typically intended to eventually drive a device (such as a lens) in a liner fashion, it is understood that the rotary motor embodiments shown herein may be utilized in any application requiring a miniature electric motor with precision positioning capability.

The invention described herein is generally directed to a rotary motor driven by a piezoelectric means utilizing electronically actuated (PZT—Lead [Pb] Zirconate Titanate) material, or equivalents thereof such as BaTiO₃ or crystals. In general, the embodiments shown herein comprise an outer structure of annular shape having teeth shaped protrusions emanating inward from its inner circumferential surface towards its axial center. This annular teethed structure comprises a resilient material such as stainless steel, aluminum, ceramic or polymer and typically has a conductive surface on one or more of its circumferential surfaces. Alternately, the entire structure could be conductive for some embodiments. Within the annular teethed structure, and in contact with the teethed protrusions, is a cylindrical center piece structure. For some embodiments, the center piece structure and the teethed protrusions would be threaded. For other embodiments, these structures would not be threaded. The difference between these threaded and non-threaded alternatives relates to whether or not rotary motion will be converted to linear motion by way of the action of threaded surfaces. While it may be preferable that the annular teethed structure implement a stator in many applications, the design of the present invention provides that either of the teethed structure or the cylindrical center piece structure may implement a stator. Thus, in an alternative embodiment, the cylindrical center piece structure may be held stationary thus implementing a stator, while the annular teethed structure is allowed to rotate when the PZT elements are electrically actuated. In order to do this, some form of electrical commutation would need to be provided to allow electrical connectivity to the annular teethed structure as it rotates. Such commutation mechanisms are well known in the art.

For the present invention, flat pads of PZT material are placed at different locations around a circumferential surface of the teethed structure. This could include the inner circumferential surface, the outer circumferential surface, or both. PZT pads make electrical contact with the conductive surface of the teethed structure, and the exposed surface of a PZT pad contains one or more electrodes attached to it as will be demonstrated. Electrical connections are made from one or more driving voltage sources to these electrodes such that when electrical power waveforms are applied to different PZT pads, these PZT pads deform causing the annular teethed structure to deform. The deformation causes the circular shape of the annular teethed structure to change to an elliptical shape. In doing so, some of the teethed protrusions are caused to withdraw from contact with the cylindrical centerpiece while other teethed protrusions continue to make contact with the cylindrical center piece and due to the elliptical deformation, cause a tangential force to be imparted. As a result, whichever structure is acting as a rotor for a particular motor configuration (cylindrical centerpiece or annular teethed structure) will rotate.

The embodiments shown here vary as to the shape of the annular teethed structure, including the addition of faceted flat surfaces to that structure. The embodiments also vary as to the number of flat facets, the number of pads of PZT material and the locations to which these pads are attached, and the configuration of a particular PZT material pad. The various embodiments described herein make the motor design flexible to achieve: Optimal size and dimension for applications, e.g. lens actuation for AF & Zoom; Resonant frequency beyond the audible range (>20 KHz); and Low peak-to-peak voltage of the drive signal.

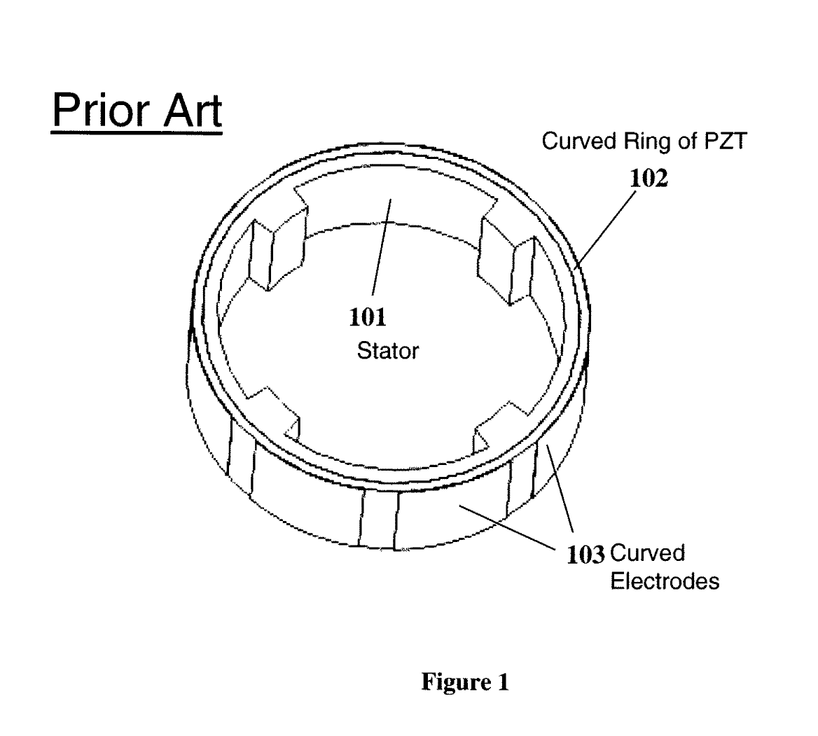

FIG. 1 shows a prior art PZT motor with curved PZT elements. In this example, a teethed structure is shown implementing a stator 101 with curved or ring shaped PZT material 102 applied to the outer circumferential surface. Curved electrodes 103 are then applied to the curved PZT material. While functional, this configuration has been shown to be difficult to manufacture. Creating curved PZT material is difficult and applying it to a curved surface is also difficult. Similarly applying a curved electrode is difficult and the resulting structures are generally seen as fragile compared with structures where flat PZT material is applied to flat surfaces. This curved PZT structure has also been shown to have a lower resonant frequency than the structures shown in the embodiments contained herein for the present invention. Controlling the resonant frequency is critically important for applications where the motor will be used within hearing distance of people. A resonant frequency less than 20 kHz can create an audible distraction that is not acceptable. For PZT thicknesses of 0.1 mm similar to the PK, CK, and PCK embodiments described for the present invention, the resonance for this prior art structure is estimated at 22.2 KHz by means of finite element analysis and simulation. Any significant variation on this frequency could place it below 20 KHz and in the audible range—an eventuality that is unacceptable for applications like cell phone cameras where the sound would be annoying to many individuals.

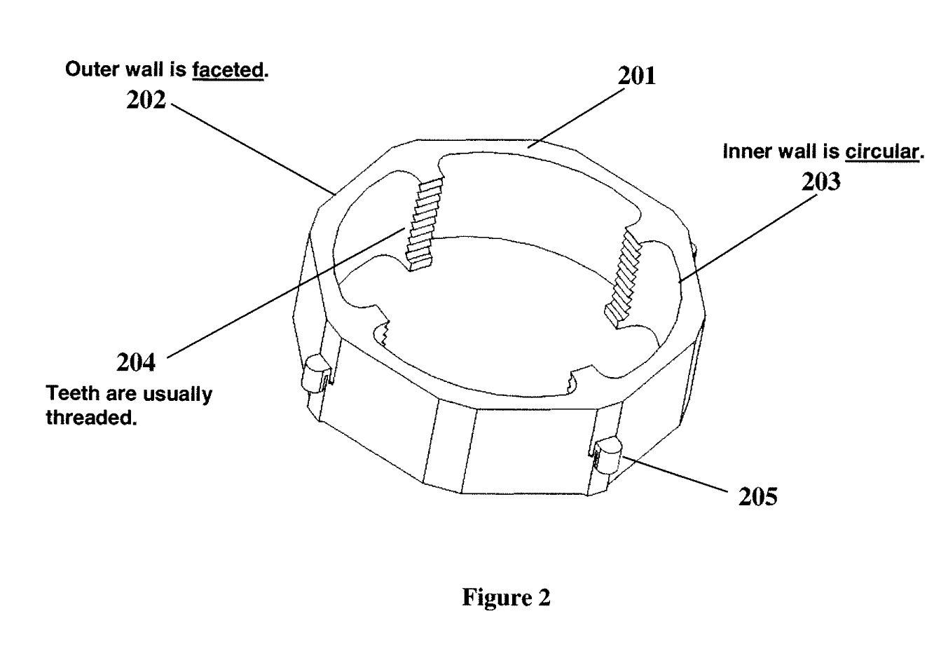

FIG. 2 shows the PK1 embodiment of the present invention describing an annular or cylindrical Teethed Structure (TS) to which a plurality of Piezoelectric Ceramic PZT elements of proper polarities may be later attached. The resulting structure deforms when driven by the proper control signal of certain amplitude and frequency. In particular, this teethed structure has its outer circumferential surface 202 cut in flat facets and inner surface 203 in circular or curved finish. Note that the teethed protrusions 204 in FIG. 2 are threaded. Potential embodiments may not require these teeth 204 to be threaded, and when threaded, the threads may be either angled or straight depending upon whether the purpose is to simply rotate the cylindrical center piece (shown later) or both rotate and axially move the cylindrical center piece in order to affect linear motion of the center piece. Also notice suspension or mounting points 205 located between flat facets on the outer circumferential surface of structure 201. These may be simply mounting tabs, or alternately may be spring-like structures as shown in FIG. 2. These spring-like structures may be molded or machined as part of structure 201, or alternately may be fabricated separately and attached to structure 201.

In embodiments, structure 201, as well as similar structures described below, is comprised of a resilient material such as stainless steel, aluminum, ceramic or polymer, is about 6 mm to 7 mm in outer diameter, about 2 mm high, and has a thickness between inner and outer walls of about 0.5 mm. These dimensions are considered suitable for embodiments useful in applications such as cell phone cameras, PDA cameras, MP3 player cameras, notebook computer cameras, medical endoscope cameras, and digital cameras in general. However, those skilled in the art will appreciate that other dimensions and applications are possible while remaining within the scope of the present invention.

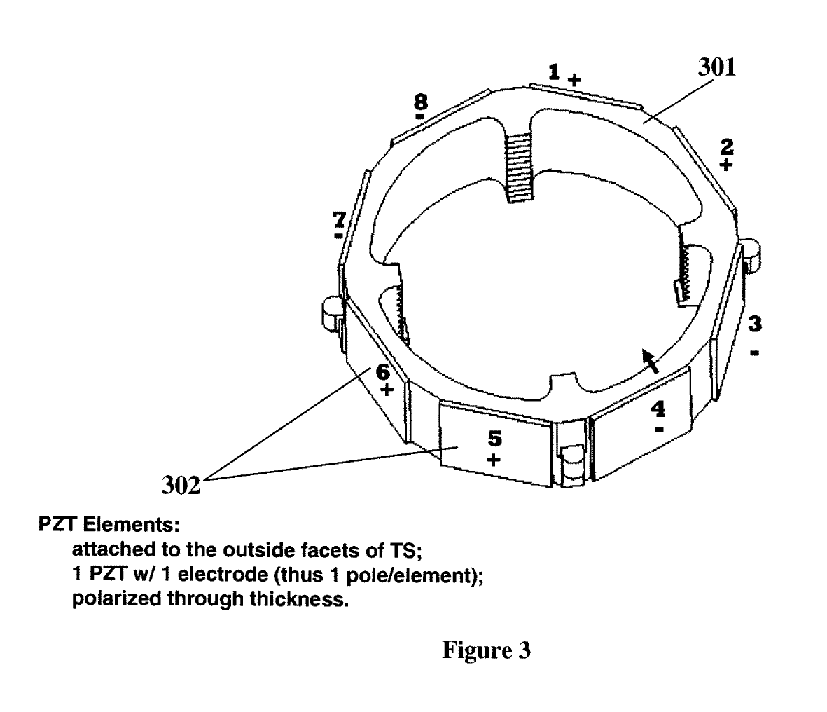

FIG. 3 shows the PK1 embodiment including annular teethed structure 301 as previously shown in FIG. 2, with eight single-electrode PZT flat elements or pads 302 attached to the facets on the outer surface forming an 8-pole deformation structure. Note the polarity of the different PZT pads, where half of the pads have a positive polarity and the other half have a negative polarity.

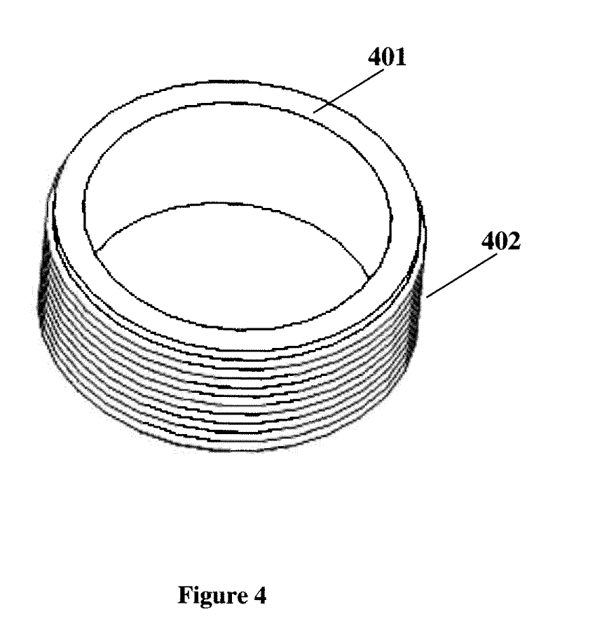

FIG. 4 shows the a cylindrical threaded center piece (TCP) structure 401 intended to fit inside a teethed structure such as for the PK1 embodiment shown in FIG. 3. As shown, the cylindrical center piece is threaded 402 although in some applications it may not be threaded. When threaded, the threads may be either flat or angled depending upon the purpose of this cylindrical centerpiece in a particular embodiment. In embodiments, structure 401, as well as similar structures described below, is comprised of any solid material with a smooth surface finish, is about 5 mm to 6 mm in diameter, about 2 mm to 15 mm high, and has a thickness between inner and outer walls of about 0.4 mm. These dimensions are considered suitable for embodiments useful in applications such as cell phone cameras, PDA cameras, MP3 player cameras, notebook computer cameras, medical endoscope cameras, and digital cameras in general. However, those skilled in the art will appreciate that other dimensions and applications are possible while remaining within the scope of the present invention.

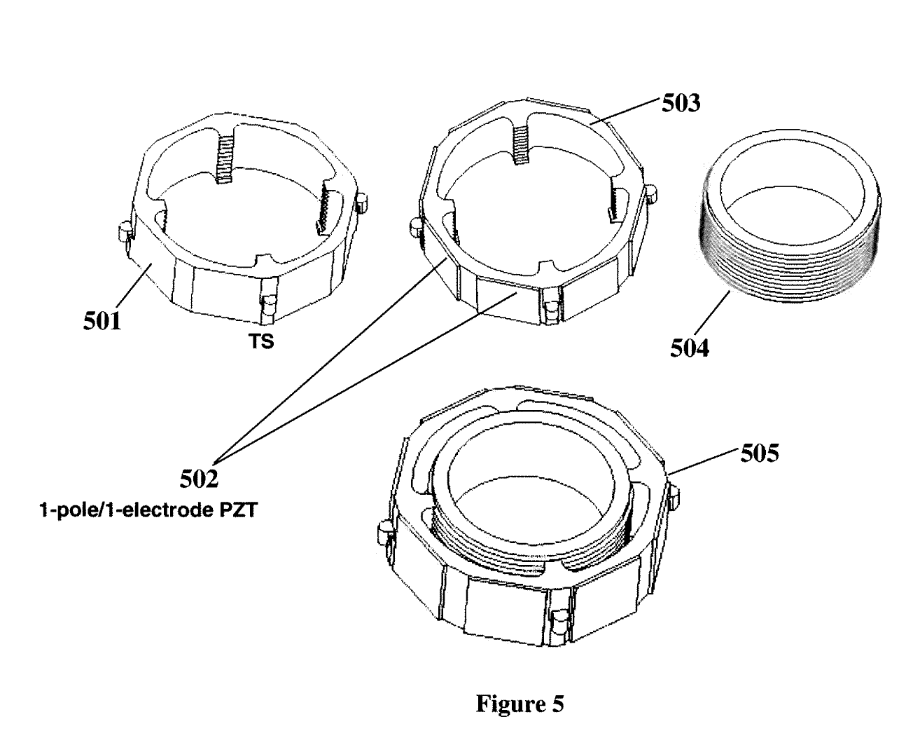

FIG. 5 shows the components of a miniature piezoelectric motor embodiment, PK1, based on the teethed structure shown in FIG. 3. The basic teethed structure 501 has flat PZT pads 502 attached to form structure 503. When combined with a cylindrical center piece 504 (in this instance a threaded center piece), the resulting assembly 505 is as shown.

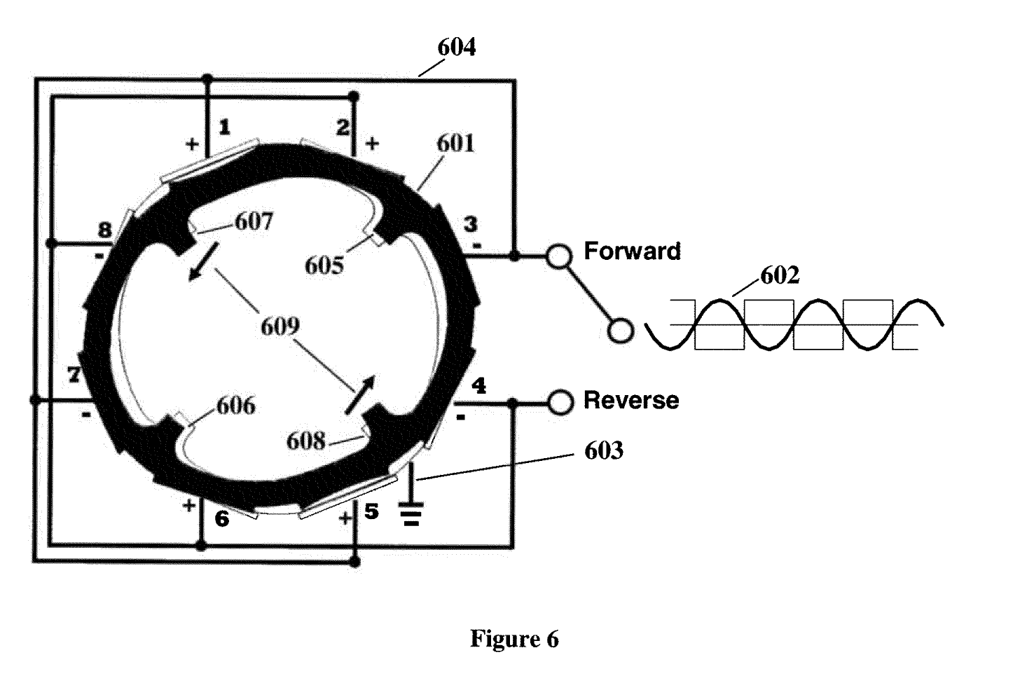

FIG. 6 shows the deformation of teethed structure 601, similar to the one shown in FIG. 3, with its poles (poles 1,3,5,7) driven by an appropriate signal 602 of proper amplitude and with a frequency matching a resonant frequency of teethed structure 601. Teethed structure 601, or the outer conductive circumferential surface thereof, is tied to ground 603. When a cylindrical threaded center piece (TCP) like the one shown in FIG. 4 is fitted inside teethed structure 601, its threads come into contact with the threads on teethed structure 601. Then, when the voltage source waveform signal 602 is applied to one set of PZT elements via connections 604, the deformation thus generated causes tooth “B” 605 and “D” 606 to disengage the TCP while Tooth “A” 607 and “C” 608 both impart a tangential force 609 to the TCP causing it to rotate in the CCW direction, if the teethed (TS/PZT) structure is held stable. Conversely, if the TCP is held stable, the same driving shall result in the TS/PCT structure rotating in the CW direction. The scheme of holding the TS/PZT structure stable to rotate the TCP results in a motor, which will be called a Type 1 motor. The scheme of holding the TCP stable to rotate the TS/PZT structure results in a motor, which will be called a Type 2 motor. The piezoelectric motors driven as described in this drawing are normally referred to as Standing Wave PZT Motors. Those skilled in the piezoelectric motor arts will recognize various possible driving circuit and voltage source implementations for realizing the signals and schemes showed in FIG. 6, as well as in similar embodiments, and so even more details thereof in addition to those provided herein will be omitted for sake of clarity of the invention.

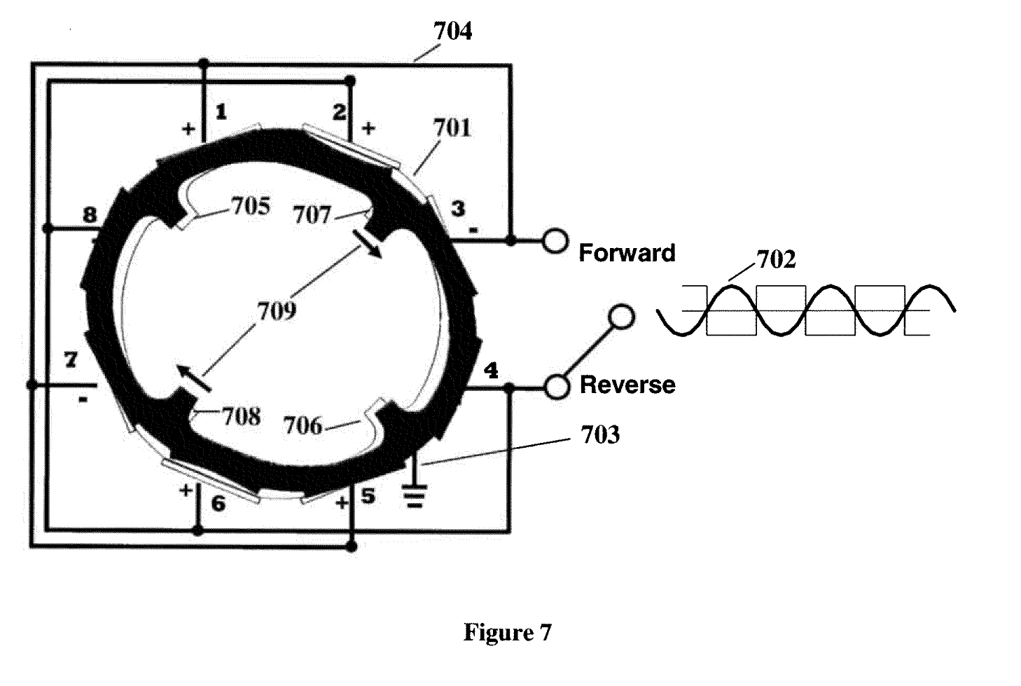

FIG. 7 shows the deformation of teethed (TS/PZT) structure 701, similar to the structure in FIG. 3, with its poles (2,4,6,8) driven by an appropriate signal 702 of proper amplitude and with a frequency matching a resonant frequency of the TS/PZT structure 701. Teethed structure 701, or the outer conductive circumferential surface thereof is tied to ground 703. When a TCP like the one shown in FIG. 4 is fitted inside structure 701, its threads come into contact with the threads on TS/PZT structure 701. Then when the voltage source waveform of signal 702 is applied to one set of PZT elements via connections 704, the deformation thus generated causes tooth “A” 705 and “C” 706 to disengage the TCP while tooth “B” 707 and “D” 708 both impart a tangential force 709 to the TCP causing it to rotate in the CW direction, if the TS/PZT structure is held stable (Type 1 motor). Conversely, if the TCP is held stable, the same driving shall result in the TS/PCT structure rotating in the CCW direction (Type 2 motor).

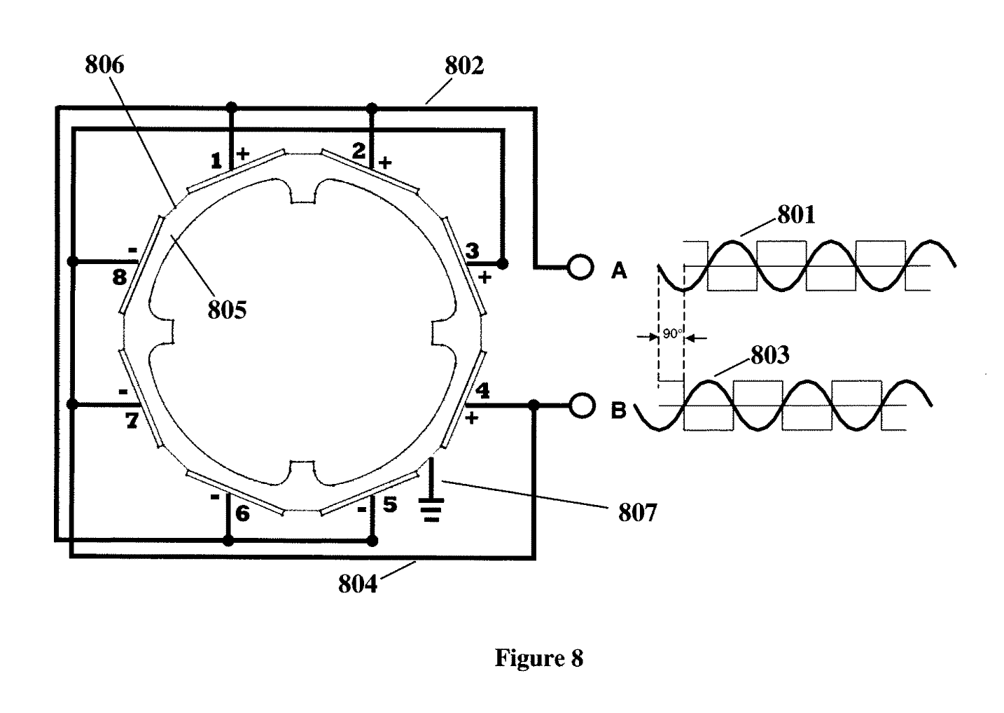

The miniature piezoelectric motors described herein can also be driven using a 2-phase signal and a Traveling Wave methodology. Per FIG. 8, a first phase 801 is connected to a first pole group (1,2,5,6) via connections 802, while the second phase 803 is connected to a second pole group (3,4,7,8) via connections 804. The teethed structure 805, or the outer conductive circumferential surface thereof 806 is tied to ground 807. The rotational direction control is achieved by altering the phase difference between the phases of drive signals 801 and 803. The PZT motors thus driven are normally referred to as Traveling Wave PZT Motors.

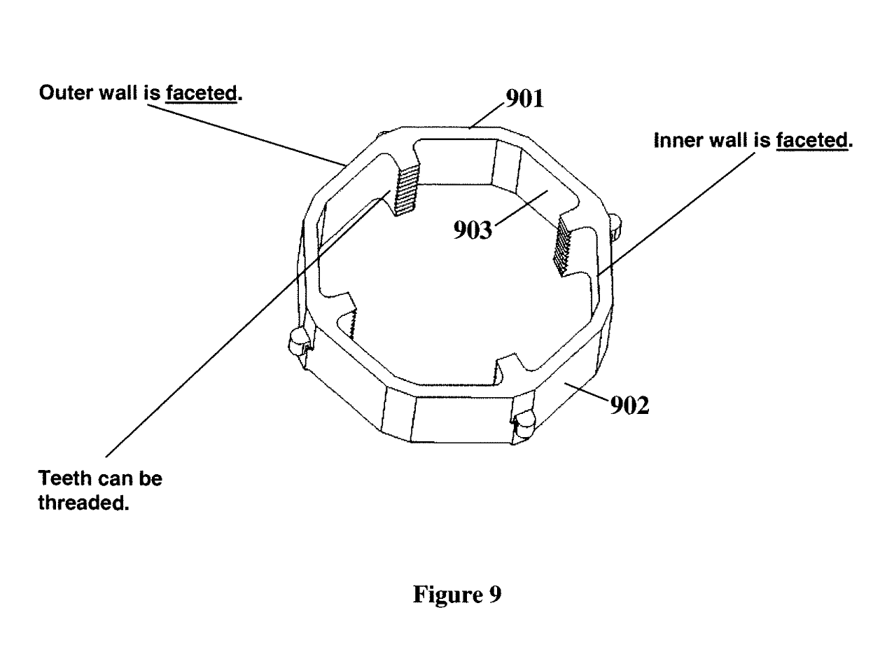

FIG. 9 shows the PK1_f embodiment of an annular teethed structure 901 to which a plurality of PZT elements of proper polarities may be later attached to form a structure for deformation when driven by the proper control signal of certain amplitude and frequency. In particular, this teethed structure has both its outer surface 902 and inner surface 903 cut in flat facets.

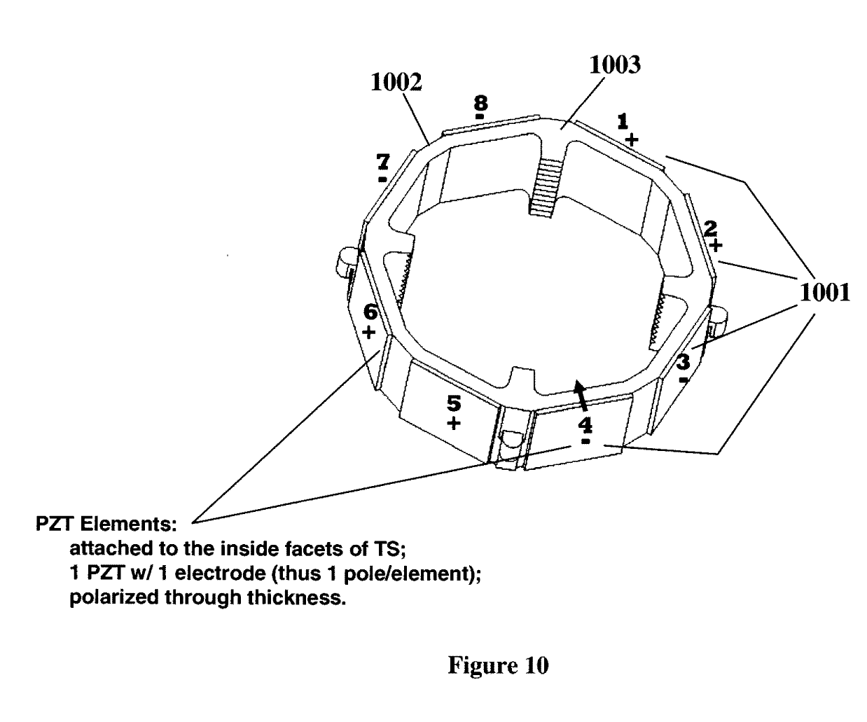

FIG. 10 shows the TS/PZT embodiment of the PK1_f-teethed structure of FIG. 9 where eight single-electrode PZT elements/pads 1001 have been attached to facets on the exterior circumferential surface 1002 of the teethed structure 1003 thereby forming an 8-pole deformation structure.

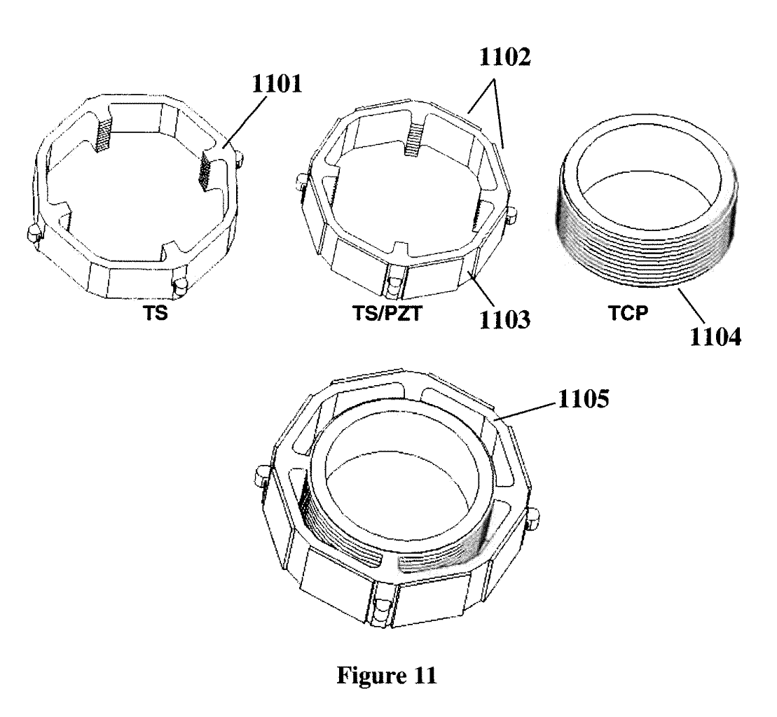

FIG. 11 shows the PK1_f embodiment of a miniature piezoelectric motor, based on the TS/PZT embodiment shown in FIG. 10. The basic teethed structure 1101 has flat PZT pads 1102 attached to form structure 1103. When combined with a cylindrical center piece 1104 (in this instance a threaded center piece), the resulting assembly 1105 is as shown.

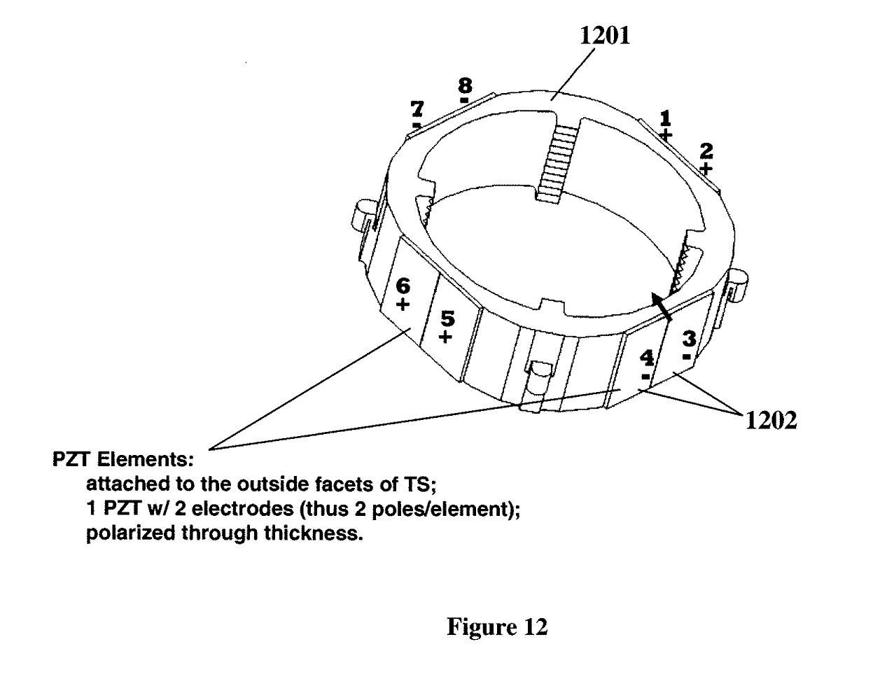

FIG. 12 shows the PK2 embodiment of a teethed structure 1201 having 4 facets on the external circumferential surface and four co-planar dual-electrode PZT elements 1202 forming an 8-pole deformation structure. Within each pair of coplanar PZT elements 1202, each element has the same polarization. In fact, the PZT material for a co-planar pair may be one continuous PZT piece. Only the electrodes are separate, enabling each segment to be driven at a different point in time, thus causing an asymmetry of forces applied to the annular teethed structure and producing an elliptical deformation similar to that shown in FIGS. 6 and 7. The PK2 embodiment is driven in the same manner as shown in FIGS. 6 and 7.

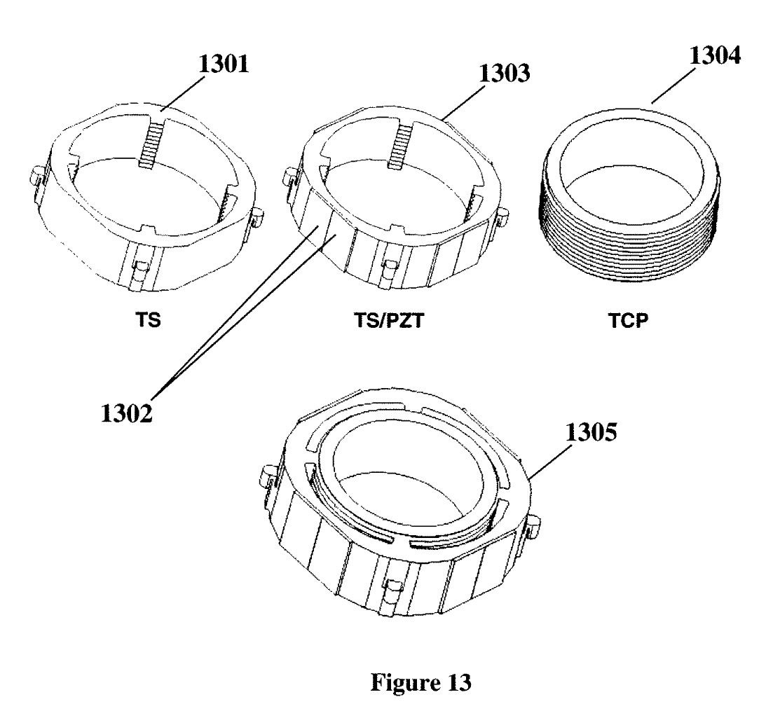

FIG. 13 shows a miniature piezoelectric motor embodiment, PK2, based on the TS/PZT embodiment shown in FIG. 12. The basic teethed structure 1301 has flat dual electrode co-planar pairs of PZT pads 1302 attached to form structure 1303. When combined with a cylindrical center piece 1304 (in this instance a threaded center piece), the resulting assembly 1305 is as shown.

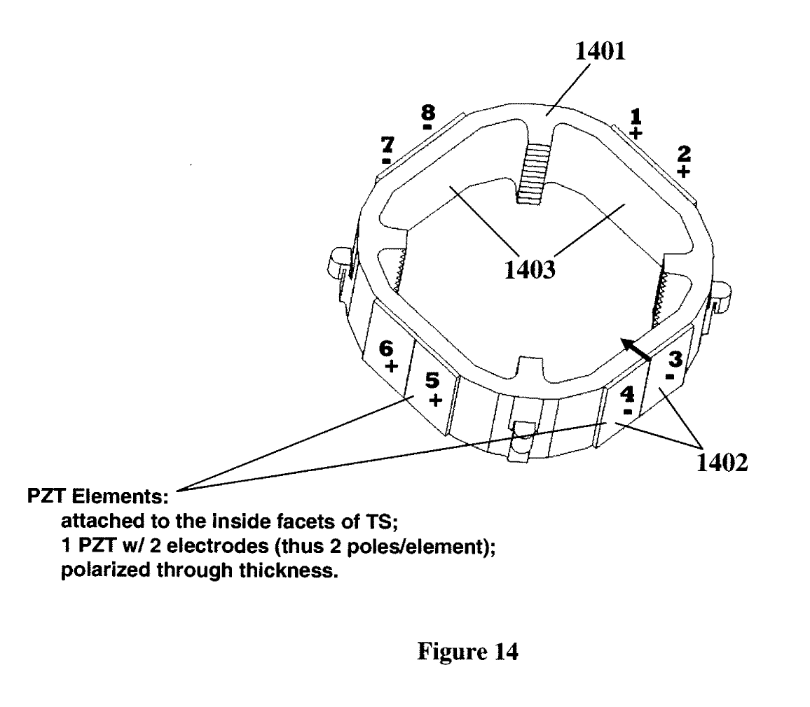

FIG. 14 shows an embodiment of the PK2_f teethed structure 1401 having four facets and four dual-electrode PZT elements 1402 forming an 8-pole deformation structure. The PK2_f embodiment of FIG. 14 is similar to the PK2 embodiment of FIG. 13, except that PK2_f embodiment also has four flat facets 1403 on the inner circumferential surface of teethed structure 1401.

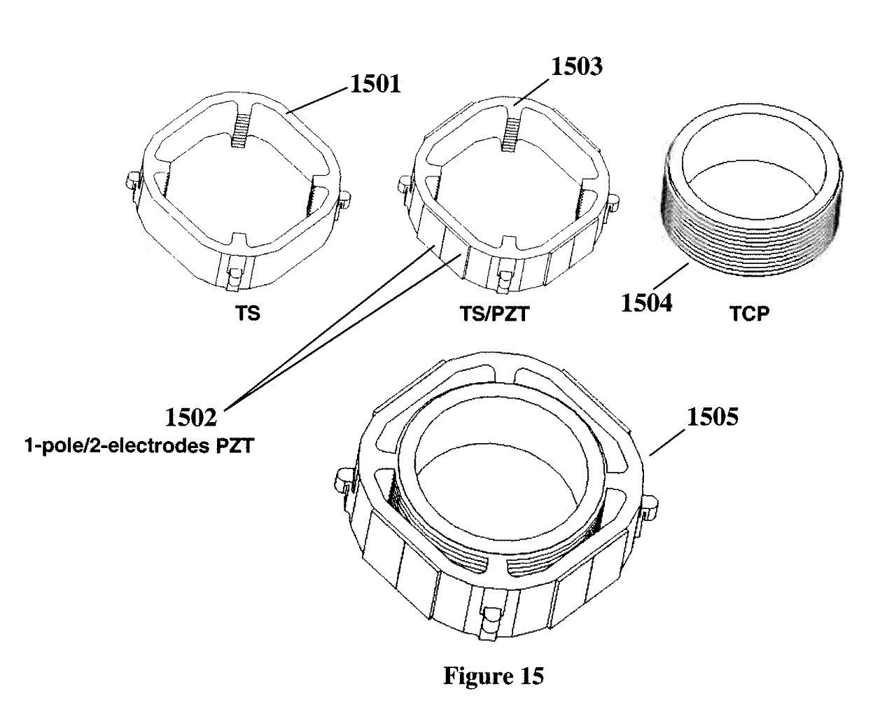

FIG. 15 shows a miniature piezoelectric motor embodiment, PK2_f, based on the TS/PZT embodiment shown in FIG. 14. The basic teethed structure 1501 has flat PZT pads 1502 each consisting of a coplanar pair of PZT elements attached to form structure 1503. When combined with a cylindrical center piece 1504 (in this instance a threaded center piece), the resulting assembly 1505 is as shown.

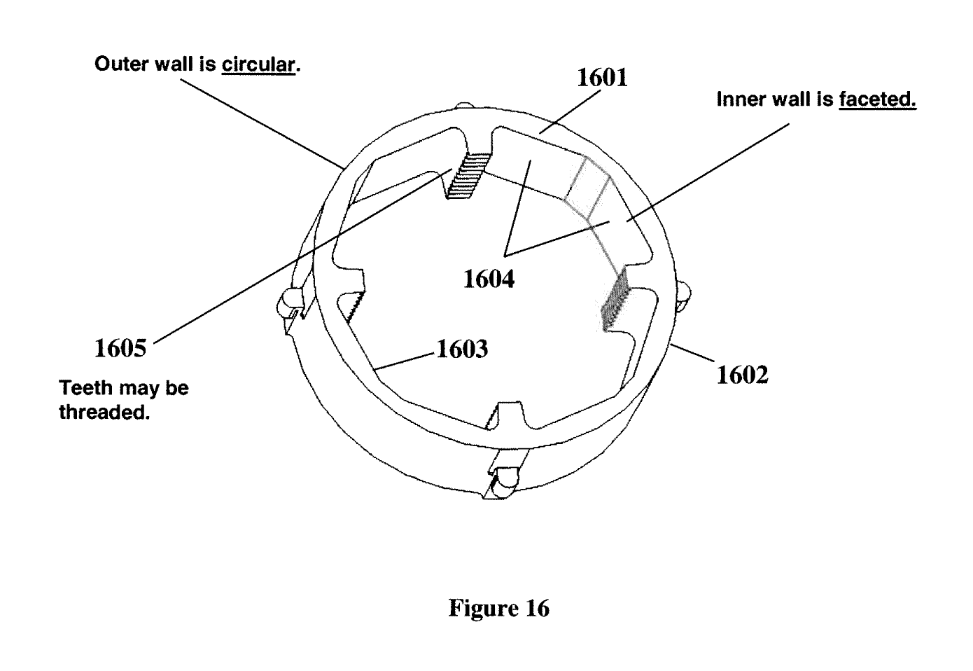

FIG. 16 shows the CK1 embodiment of an annular teethed structure 1601 to which a plurality of PZT elements or pads of proper polarities may be attached to form a structure for deformation when driven by the proper control signal of certain amplitude and frequency. In particular, this teethed structure has its outer circumferential surface 1602 in circular finish and inner circumferential surface 1603 cut in flat facets 1604. Placing the PZT pads on inner surface 1603 has the added advantage of making the overall dimensions of the motor smaller since the PZT pads reside in the spaces between teethed protrusions 1605 that would otherwise have been wasted space. Positioning the PZT pads on the inner surface also offers protection for the PZT elements after they are attached during the handling and final assembly process for the motor.

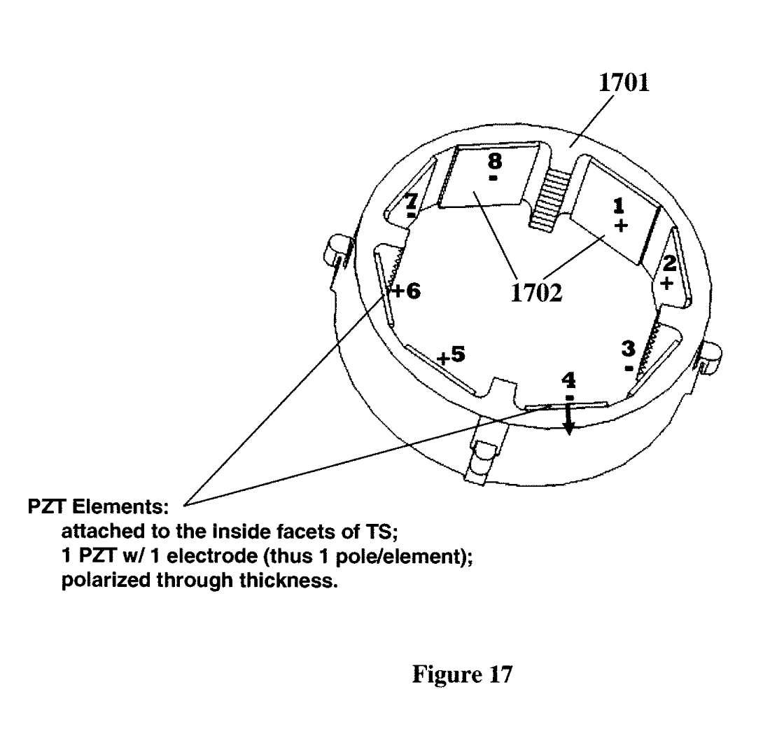

FIG. 17 shows the teethed structure 1701 of the CK1 embodiment as in FIG. 16 with eight single-electrode PZT elements 1702 attached to the facets on the inner surface of the teethed structure forming an 8-pole deformation structure.

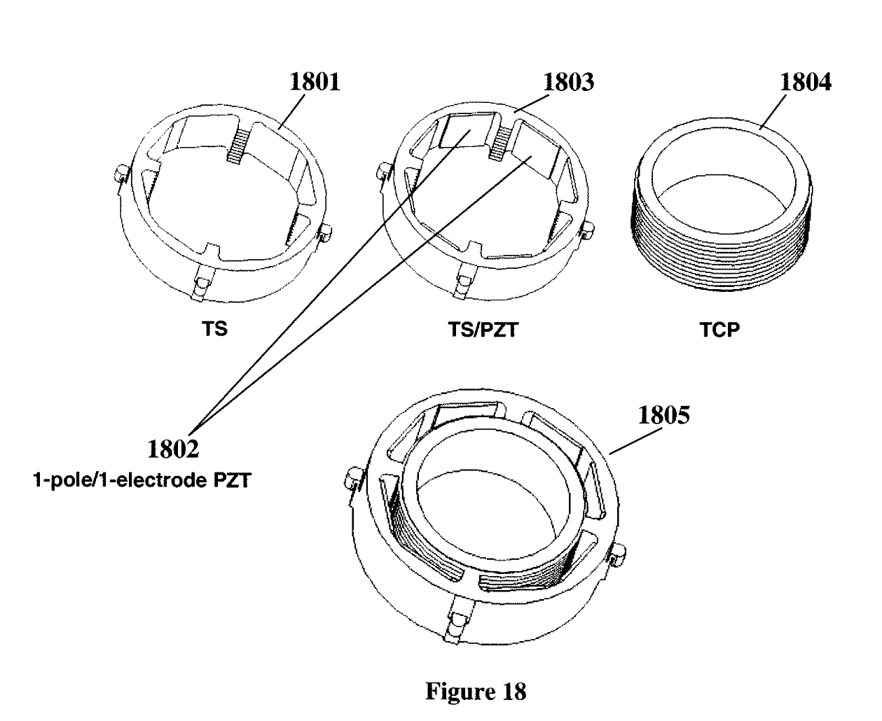

FIG. 18 shows a miniature piezoelectric motor embodiment, CK1, based on the TS/PZT embodiment shown in FIG. 17. The basic teethed structure 1801 has flat PZT pads 1802 attached to facets on the inner surface to form structure 1803. When combined with cylindrical center piece 1804 (in this instance a threaded center piece), the resulting assembly 1805 is as shown.

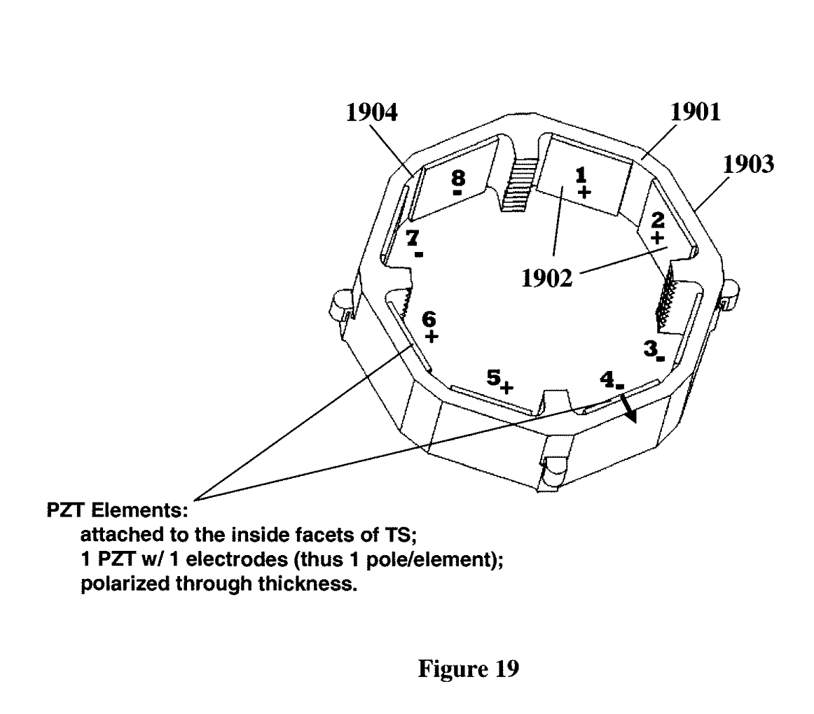

FIG. 19 shows the CK1_f embodiment 1901 of a teethed structure and eight single-electrode PZT elements 1902 forming an 8-pole deformation structure. Here, both the outer circumferential surface 1903 and inner circumferential surface 1904 of the teethed structure are faceted.

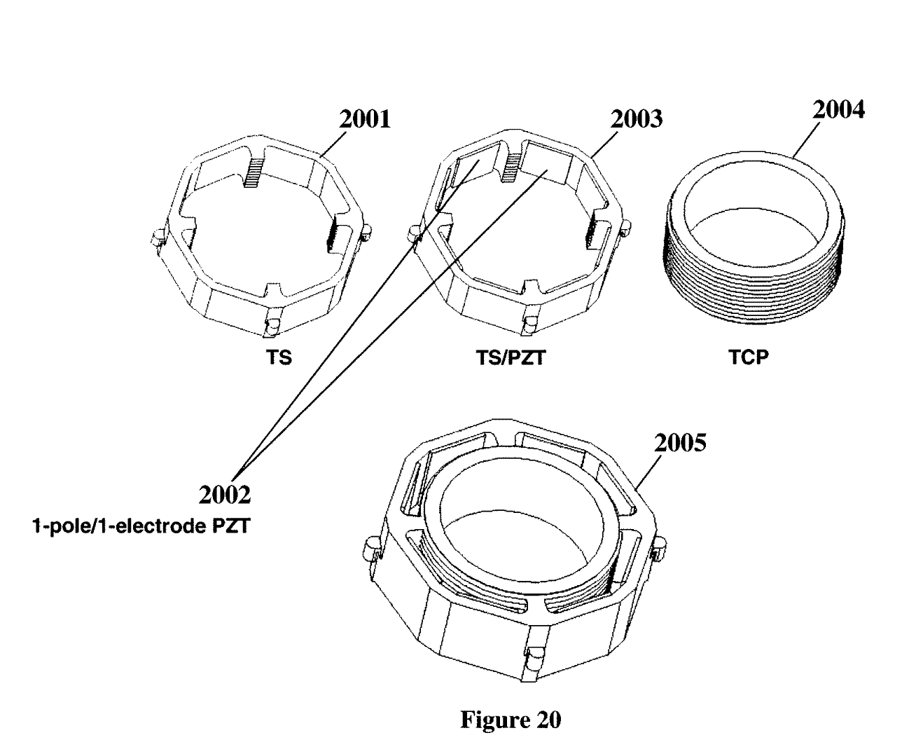

FIG. 20 shows the miniature piezoelectric motor embodiment, CK1_f, based on the TS/PZT embodiment shown in FIG. 19. The basic teethed structure 2001 has flat PZT pads 2002 attached to form structure 2003. When combined with a cylindrical center piece 2004 (in this instance a threaded center piece), the resulting assembly 2005 is as shown.

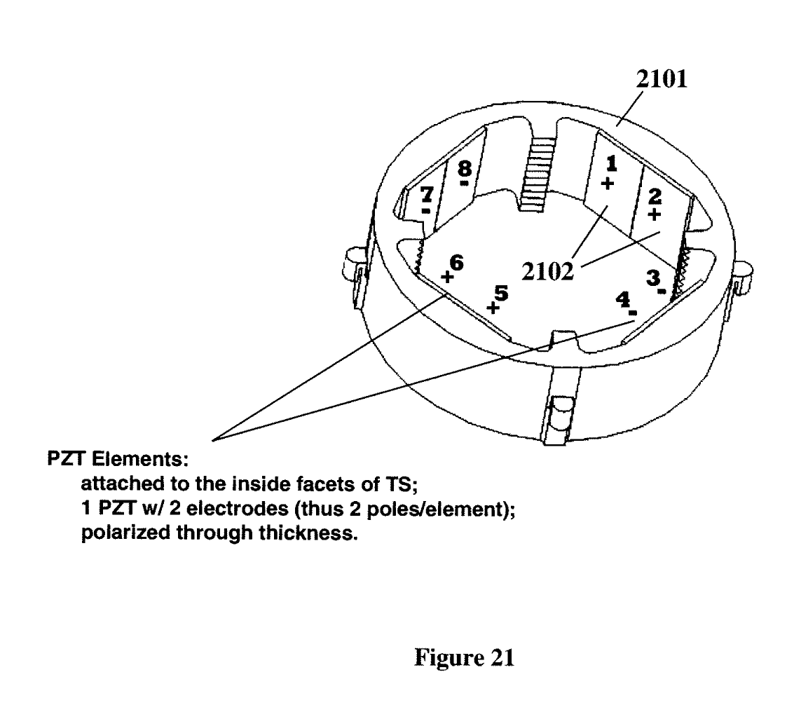

FIG. 21 shows the CK2 embodiment of a teethed structure 2101 where four dual-electrode co-planar PZT elements 1202 are attached on the inner circumferential surface of the annular teethed structure thereby forming an 8-pole deformation structure.

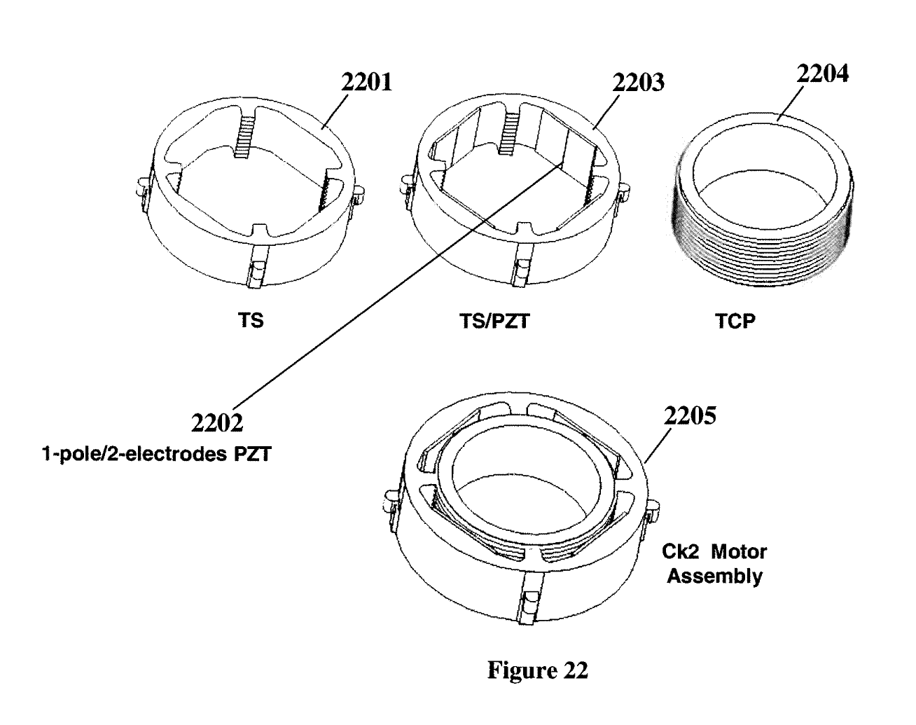

FIG. 22 shows the miniature piezoelectric motor embodiment CK2, based on the TS/PZT embodiment shown in FIG. 21. The basic teethed structure 2201 has flat dual electrode coplanar pairs of PZT pads 2202 attached to facets on the inner circumferential surface to form structure 2203. When combined with a cylindrical center piece 2204 (in this instance a threaded center piece), the resulting assembly 2205 is as shown.

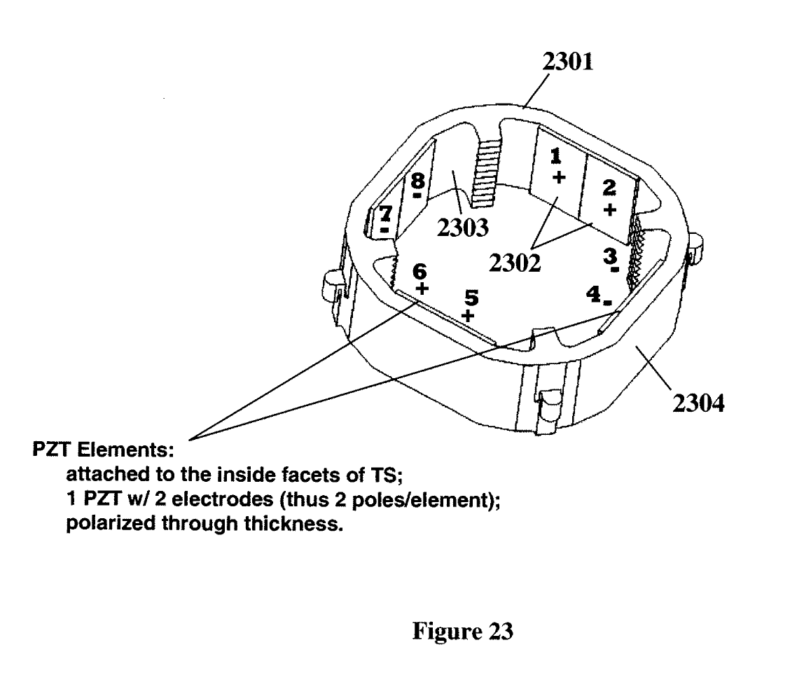

FIG. 23 shows the CK2_f embodiment of a teethed structure 2301 where four dual-electrode coplanar PZT elements 2302 are attached on the inner circumferential surface of the annular teethed structure 2301 thereby forming an 8-pole deformation structure. In this embodiment, both the inner circumferential surface 2303 and outer circumferential surface 2304 of the annular teethed structure are faceted.

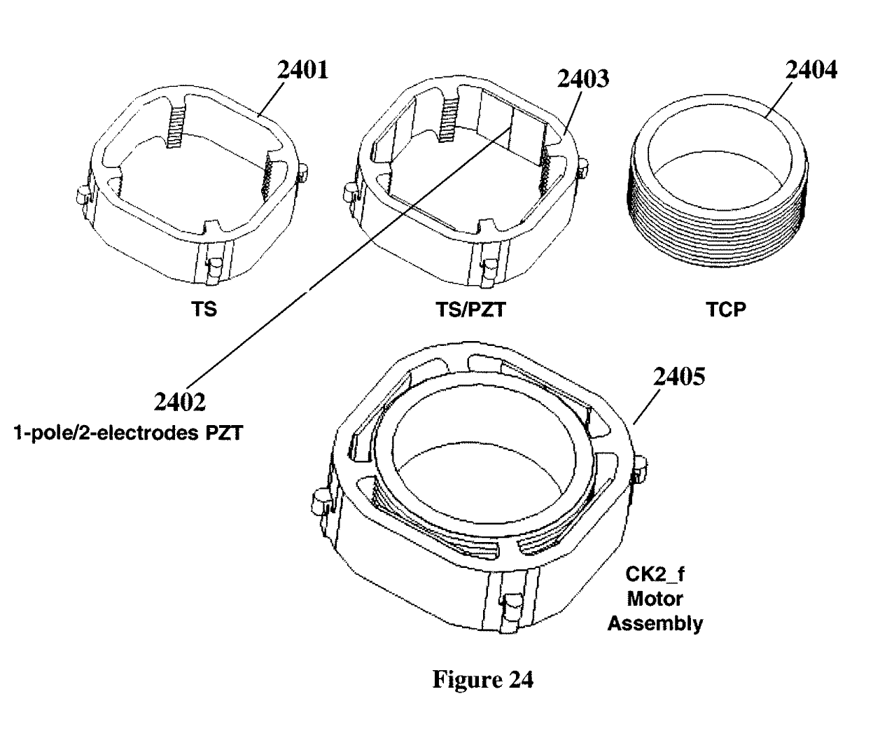

FIG. 24 shows one miniature piezoelectric motor embodiment, CK2_f, based on the TS/PZT embodiment shown in FIG. 23. The basic teethed structure 2401 has flat coplanar dual-electrode PZT pads 2402 attached to form structure 2403. When combined with a cylindrical center piece 2404 (in this instance a threaded center piece), the resulting assembly 2405 is as shown.

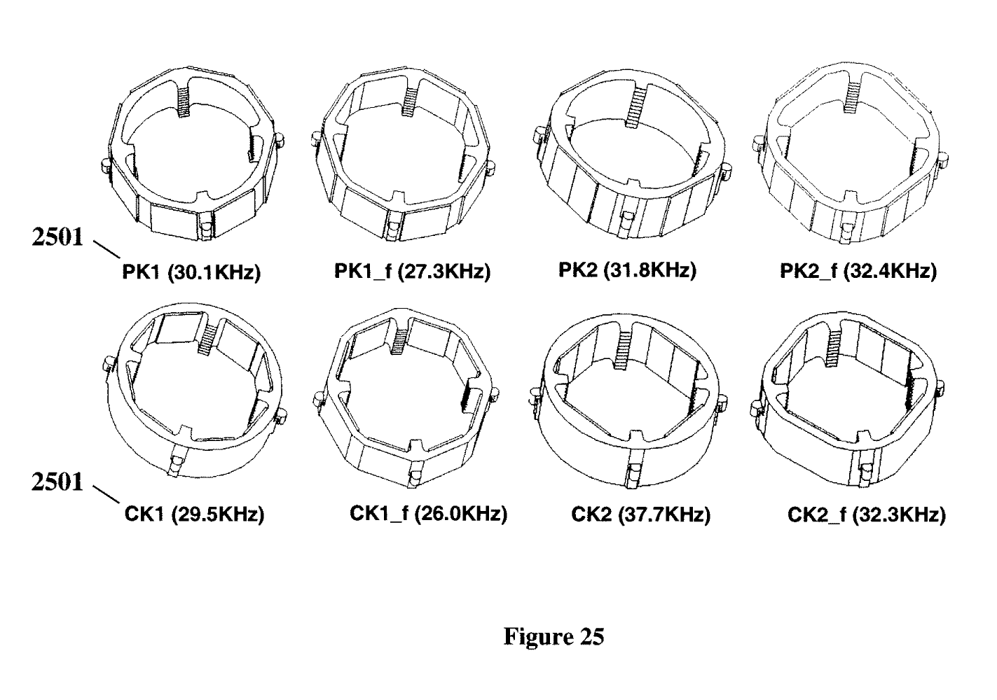

FIG. 25 shows eight embodiments of an annular teethed structure with attached PZT elements as previously described in FIGS. 3, 10, 12, 14, 17, 19, 21, and 23. The differences between these structures with regard to number and placement of facets, as well as configuration of PZT pads enables various design optimizations for dimensions, resonant frequency, and drive signal voltage. Under the image for each embodiment in FIG. 25 is shown the resonant frequency 2501 for that embodiment as determined by finite element analysis and simulation. The calculated resonant frequencies for the structures shown in FIG. 25 are:

| | |
|---|---|
| PK1 | 30.1 KHz |
| PK1_f | 27.3 KHz |
| PK2 | 31.8 KHz |
| PK2_f | 32.4 KHz |
| CK1 | 29.5 KHz |
| CK1_f | 26.0 KHz |
| CK2 | 37.7 KHz |
| CK2_f | 32.3 KHz |

It can be seen from these resonant frequency results that the use of coplanar dual electrode PZT pads has a tendency to raise the resonant frequency. In addition to the parameters mentioned above such as number and placement of facets as well as configuration of PZT pads, the cross-section thickness of the teethed structure will have a substantial effect on the resonant frequency. Varying all of these parameters as well as the material from which the teethed structure is fabricated will allow the motor designer to tune the structure for the desired resonance frequency within the scope of the present invention.

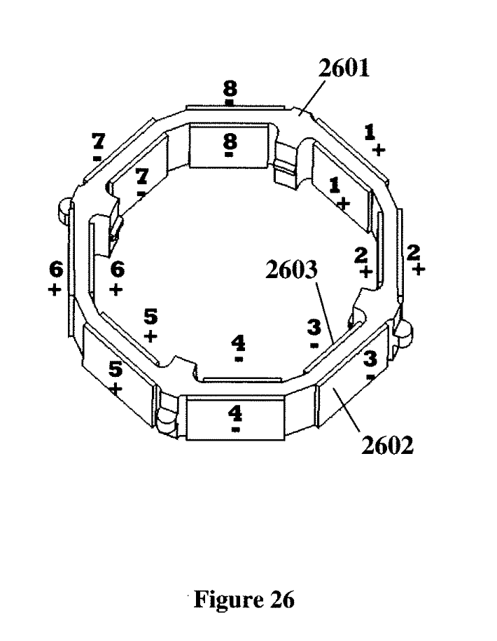

FIG. 26 shows the PCK1 embodiment of an annular teethed structure 2601 where both the inner and outer circumferential surfaces of the annular teethed structure are faceted. In this embodiment, PZT pads are attached to facets on both sides of teethed structure 2601. For any particular facet, the PZT pad 2602 on the outer circumferential surface will have the same polarity as the corresponding PZT pad 2603 on the inner circumferential surface. This provides the ability for both PZT pads on a particular facet to work in unison while being driven simultaneously in order to affect a larger stretching or shrinking of the teethed structure material for that facet than a single PZT pad alone could have accomplished.

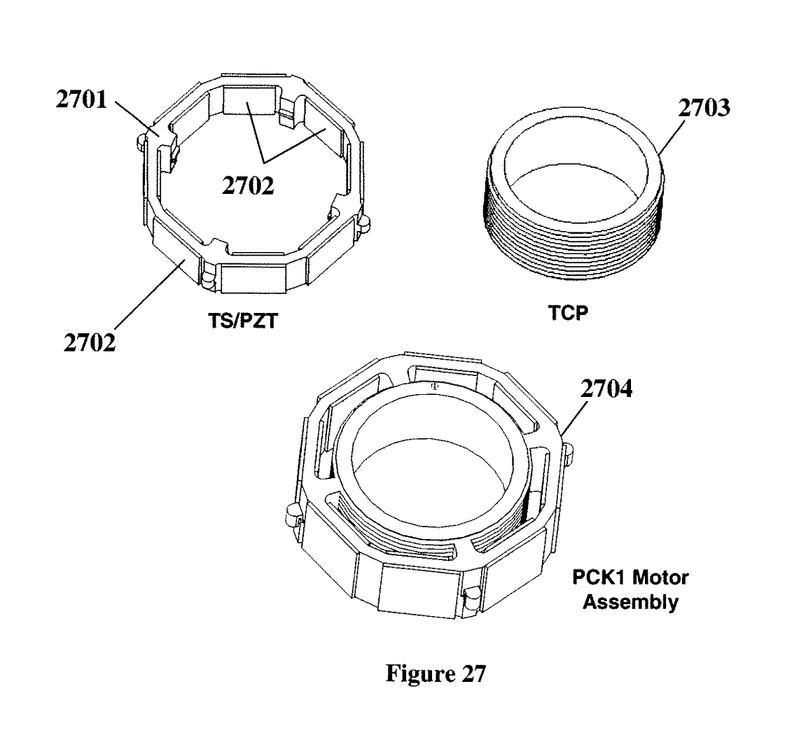

FIG. 27 shows one miniature piezoelectric motor embodiment, PCK1, based on the TS/PZT embodiment shown in FIG. 26. The basic teethed structure 2701 has flat PZT pads 2702 added on each facet of teethed structure 2701. When combined with cylindrical center piece 2703 (in this instance a threaded center piece), the resulting motor assembly 2704 is as shown.

The PCK2 embodiment (not shown) represents a variation on the structures shown in FIGS. 26 and 27, and is created by reducing the number of facets from eight to four, and utilizing flat coplanar dual-electrode PZT pads attached to each facet both on the inner and outer circumferential surfaces of the teethed structure, in a manner similar to FIGS. 14 and 23.

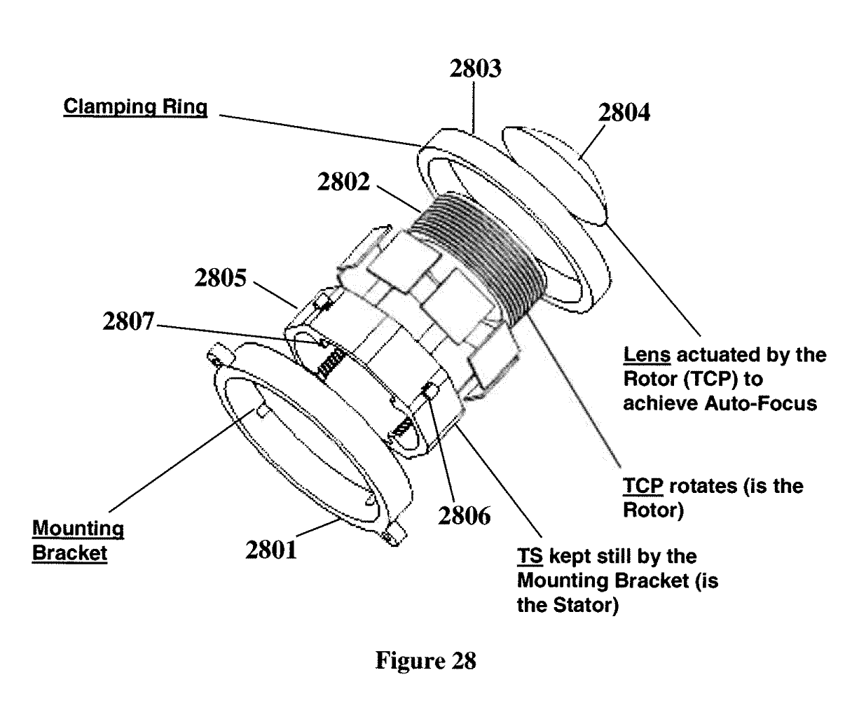

FIG. 28 shows the mounting of a PK1 Type 1 miniature piezoelectric motor using a mounting bracket 2801, which could have fins or a flange (not shown) to act as the hard stop for the rotor (TCP) 2802. Also included is a clamping ring 2803 which contains the motor assembly by holding it against mounting bracket 2801. The drawing also shows how camera lens 2804 fitted to rotor 2802 can be actuated in the axial direction to achieve auto-focus. For this type I motor configuration, teethed structure 2805 is held stationary (as a stator) by mounting tabs 2806 while rotor 2802 is allowed to rotate. Spiral threads on rotor 2802 provide linear movement as it rotates thereby moving camera lens 2804 axially to affect the autofocus function. Hard stop tabs 2807 shown here are implemented as extended teeth on the stator. These may alternately be implemented as hard stop tabs attached to mounting bracket 2801.

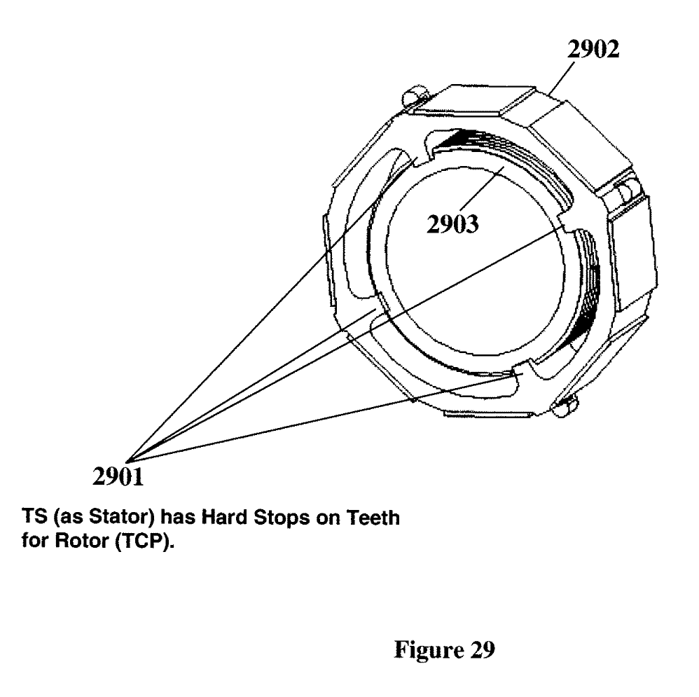

FIG. 29 shows a PK1 Type 1 miniature piezoelectric motor with hard stop tabs 2901 on stator 2902 that determine the limit of travel for rotor 2903.

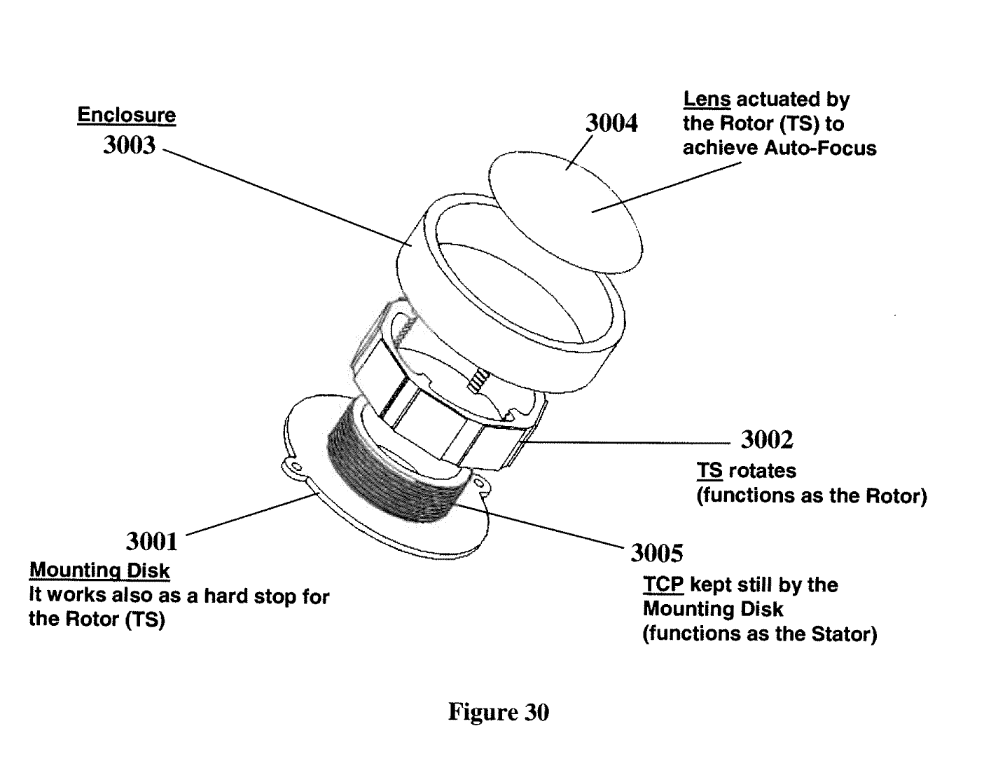

FIG. 30 shows the mounting of a PK1 Type 2 miniature piezoelectric motor using a mounting disk 3001, which also acts as the hard stop for rotor 3002, which for a type 2 motor is a teethed structure. An enclosure 3003 for the motor is also shown. FIG. 30 also shows how a camera lens 3004 fitted on rotor 3002 can be actuated to achieve auto-focus. Cylindrical threaded center piece (TCP) structure 3005 is kept stationary by attachment to mounting disk 3001 hence functioning as the stator for this Type 2 motor configuration.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. For example, steps preformed in the embodiments of the invention disclosed can be performed in alternate orders, certain steps can be omitted, and additional steps can be added. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

What is claimed is:

1. A piezoelectric motor comprising:
an annular teethed structure of resilient material having teethed protrusions that emanate inward and having a conductive surface on the outer circumferential surface, wherein the conductive surface comprises a plurality of flat facets;
a flat pad of piezoelectric material structurally and electrically bonded to each of said flat facets, wherein each pad of piezoelectric material includes electrodes on both flat surfaces of said pad;
a cylindrical center piece structure placed within the annular teethed structure, said cylindrical center piece structure normally in contact with said protrusions that emanate inward from the annular teethed structure; and
wherein each pad of piezoelectric material is capable of being electrically driven by a voltage source in order to elliptically deform the annular teethed structure, thereby causing some of said protrusions to withdraw from contact with the cylindrical center piece structure while others of said protrusions remain in contact with the cylindrical center piece structure while applying a tangential force thereto, resulting in the mechanical movement of either the annular teethed structure or the cylindrical center piece structure.

2. The motor of claim 1 wherein the inner circumferential surface of the annular teethed structure is not faceted.

3. The motor of claim 1 wherein the inner circumferential surface of the annular teethed structure comprises the same number of facets as the outer circumferential surface.

4. The motor according to claim 1, wherein half of said pads of piezoelectric material are driven in common by a voltage source at a first point in time, and the other half of said pads of piezoelectric material are driven in common by a voltage source at a second point in time.

5. The motor according to claim 1 where the annular teethed structure comprises a stator, including at least two mounting tabs on the exterior surface of said stator, said mounting tabs positioned between pads of piezoelectric material.

6. The motor according to claim 1 where the cylindrical center piece structure comprises a rotor, and wherein a portion of said protrusion includes an extension that serves as a stop to determine the retracted position of the rotor.

7. The motor according to claim 1 where the cylindrical center piece structure comprises a rotor, and including a mounting plate that serves as a stop to determine the retracted position of the rotor.

8. The motor according to claim 7 wherein said mounting plate includes a central hole to enable light to pass through the center of the motor.

9. The motor of claim 1 wherein:
the annular teethed structure comprises four flat facets; and
the flat pad of piezoelectric material applied to each facet of the conductive surface comprises a pair of coplanar segments of piezoelectric material wherein each segment within said pair is polarized similarly to the other segment within the pair.

10. The motor of claim 9 wherein the inner circumferential surface of the annular teethed structure is not faceted.

11. The motor of claim 9 wherein the inner circumferential surface of the annular teethed structure comprises four facets.

12. The motor according to claim 9, wherein half of said segments of piezoelectric material are driven in common by a voltage source at a first point in time, and the other half of said segments of piezoelectric material are driven in common by a voltage source at a second point in time.

13. The motor according to claim 9 wherein the annular teethed structure comprises a stator, and including at least two mounting tabs on the exterior surface of the stator, said mounting tabs positioned between pads of piezoelectric material.

14. The motor according to claim 9 where the cylindrical center piece structure comprises a rotor, and wherein a portion of at least one protrusion includes an extension that serves as a stop to determine the retracted position of the rotor.

15. The motor according to claim 9 where the cylindrical center piece structure comprises a rotor, and including a mounting plate that serves as a stop to determine the retracted position of the rotor.

16. The motor according to claim 15 wherein said mounting plate includes a central hole to enable light to pass through the center of the motor.

17. A piezoelectric motor comprising:
an annular teethed structure of resilient material having a conductive surface on the inner circumferential surface, wherein the conductive surface comprises a plurality of flat facets;
a flat pad of piezoelectric material structurally and electrically bonded to each of said flat facets, wherein each pad of piezoelectric material includes electrodes on both flat surfaces of said pad;
a cylindrical center piece structure placed within the annular teethed structure, said cylindrical center piece structure normally in contact with protrusions that emanate inward from the annular teethed structure, said protrusions being positioned between pads of piezoelectric material; and
wherein each pad of piezoelectric material is capable of being electrically driven by a voltage source in order to elliptically deform the annular teethed structure, thereby causing some of said protrusions to withdraw from contact with the cylindrical center piece structure while others of said protrusions remain in contact with the cylindrical center piece structure while applying a tangential force thereto, resulting in the mechanical movement of either the annular teethed structure or the cylindrical center piece structure.

18. The motor of claim 17 wherein the outer circumferential surface of the annular teethed structure is not faceted.

19. The motor of claim 17 wherein the outer circumferential surface of the annular teethed structure comprises the same number of facets as the inner circumferential surface.

20. The motor according to claim 17, wherein half of said pads of piezoelectric material are driven in common by a voltage source at a first point in time, and the other half of said pads of piezoelectric material are driven in common by a voltage source at a second point in time.

21. The motor according to claim 17 where the annular teethed structure comprises a stator, including at least two mounting tabs on the exterior surface of the stator.

22. The motor according to claim 17 where the cylindrical center piece structure comprises a rotor, and wherein a portion of said protrusion includes an extension that serves as a stop to determine the retracted position of the rotor.

23. The motor according to claim 17 where the cylindrical center piece structure comprises a rotor, and including a mounting plate that serves as a stop to determine the retracted position of the rotor.

24. The motor according to claim 23 wherein said mounting plate includes a central hole to enable light to pass through the center of the motor.

25. The motor of claim 17 wherein:
the annular teethed structure comprises four flat facets; and
the flat pad of piezoelectric material applied to each facet of the conductive surface comprises a pair of coplanar segments of piezoelectric material wherein each segment within said pair is polarized similarly to the other segment within the pair.

26. The motor of claim 25 wherein the outer circumferential surface of the annular teethed structure is not faceted.

27. The motor of claim 25 wherein the outer circumferential surface of the annular teethed structure comprises four facets.

28. The motor according to claim 25, wherein half of said segments of piezoelectric material are driven in common by a voltage source at a first point in time, and the other half of said segments of piezoelectric material are driven in common by a voltage source at a second point in time.

29. The motor according to claim 25 where the annular teethed structure comprises a stator, including at least two mounting tabs on the exterior surface of the stator.

30. The motor according to claim 25 where the cylindrical center piece structure comprises a rotor, and wherein a portion of at least one protrusion includes an extension that serves as a stop to determine the retracted position of the rotor.

31. The motor according to claim 25 where the cylindrical center piece structure comprises a rotor, and including a mounting plate that serves as a stop to determine the retracted position of the rotor.

32. The motor according to claim 31 wherein said mounting plate includes a central hole to enable light to pass through the center of the motor.

33. A piezoelectric motor comprising:
an annular teethed structure of resilient material having conductive surfaces on the inner and outer circumferential surfaces, wherein the conductive surfaces comprises a plurality of flat facets;
a flat pad of piezoelectric material structurally and electrically bonded to each of said flat facets, wherein each pad of piezoelectric material includes electrodes on both flat surfaces of said pad;
a cylindrical center piece structure placed within the annular teethed structure, said cylindrical center piece structure normally in contact with protrusions that emanate inward from the annular teethed structure, said protrusions being positioned between pads of piezoelectric material; and
wherein each pad of piezoelectric material is capable of being electrically driven by a voltage source in order to elliptically deform the annular teethed structure, thereby causing some of said protrusions to withdraw from contact with the cylindrical center piece structure while others of said protrusions remain in contact with the cylindrical center piece structure while applying a tangential force thereto, resulting in the mechanical movement of either the annular teethed structure or the cylindrical center piece structure.

34. The motor according to claim 33, wherein half of said pads of piezoelectric material are driven in common by a voltage source at a first point in time, and the other half of said pads of piezoelectric material are driven in common by a voltage source at a second point in time.

35. The motor according to claim 33, including at least two mounting tabs on the exterior surface of the annular teethed structure positioned between PZT pads.

36. The motor according to claim 33 where the cylindrical center piece structure comprises a rotor, and wherein a portion of said protrusion includes an extension that serves as a stop to determine the retracted position of the rotor.

37. The motor according to claim 33 where the cylindrical center piece structure comprises a rotor, and including a mounting plate that serves as a stop to determine the retracted position of the rotor.

38. The motor according to claim 37 wherein said mounting plate includes a central hole to enable light to pass through the center of the motor.

39. The motor of claim 33 wherein:
the annular teethed structure comprises four flat facets on the outer surface and four flat facets on the inner surface of said annular teethed structure; and
the flat pad of piezoelectric material applied to each facet of a conductive surface comprises a pair of coplanar segments of piezoelectric material wherein each segment within said pair is polarized similarly to the other segment within the pair.

40. The motor of claim 39 wherein the inner and outer circumferential surfaces of the annular teethed structure each comprise four facets.

41. The motor according to claim 39, wherein half of said segments of piezoelectric material are driven in common by a voltage source at a first point in time, and the other half of said segments of piezoelectric material are driven in common by a voltage source at a second point in time.

42. The motor according to claim 39 where the annular teethed structure comprises a stator, including at least two mounting tabs on the exterior surface of the stator positioned between PZT tabs.

43. The motor according to claim 39 where the cylindrical center piece structure comprises a rotor, and wherein a portion of at least one protrusion includes an extension that serves as a stop to determine the retracted position of the rotor.

44. The motor according to claim 39 where the cylindrical center piece structure comprises a rotor, including a mounting plate that serves as a stop to determine the retracted position of the rotor.

45. The motor according to claim 44 wherein said mounting plate includes a central hole to enable light to pass through the center of the motor.

46. A piezoelectric motor comprising:
An annular stator of resilient material having teeth protrusions that emanate inward and having at least one conductive circumferential surface, wherein at least one circumferential surface of said stator comprises a plurality of flat facets;
A plurality of flat pads of piezoelectric material structurally and electrically bonded to a plurality of flat facets, wherein each pad of piezoelectric material includes electrodes on both flat surfaces of said pad;
a rotor placed within the stator, said rotor normally in contact with said protrusions that emanate inward from the stator; and
wherein each pad of piezoelectric material is capable of being electrically driven by a voltage source in order to elliptically deform the stator, thereby causing some of said protrusions to withdraw from contact with the rotor while others of said protrusions remain in contact with the rotor while applying a tangential force thereto, resulting in the mechanical movement of the rotor

47. The motor claim 46 including at least two mounting structures attached to the exterior surface of the stator.

48. The motor claim 47 where said mounting structures comprise spring structures that are molded or machined as part of the formation of the stator.

49. The motor claim 47 where said mounting structures include spring structures that are fabricated separately from the stator and may be later attached to the stator.
